(19) United States
(12) Patent Application Publication
(10) Pub. No.: US 2002/0103941 A1
(43) Pub. Date: Aug. 1, 2002

(54) Method and apparatus for launching heterogeneous software programs via a common program

(76) Inventors: Thomas Yip, Fort Collins, CO (US); John M. Baron, Longmont, CO (US); John P. Dutton, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/774,317

(22) Filed: Jan. 31, 2001

(51) Int. Cl. G06F 15/163; G06F 9/54; G06F 9/00

(52) U.S. Cl. 709/310

(57) ABSTRACT

A method and an apparatus that enable heterogeneous application programs to be consistently launched, regardless of the execution methods used to launch the application programs. The present invention comprises a memory device and logic, which is configured to execute a common launch program upon determining that an application has been invoked. For each application that utilizes the present invention, a key, a current working directory (CWD), and command information associated with the application are stored in the memory device. When the logic determines that an application program has been invoked, the logic uses identity information relating to the application to locate the key, the command information and the CWD associated with the application and uses the located command information and CWD to launch said particular application.

### TECHNICAL FIELD OF THE INVENTION

The present invention generally relates to a method and an apparatus for launching software programs. More particularly, the present invention utilizes a common program to launch software programs regardless of the execution methods that are used to execute them.

### BACKGROUND OF THE INVENTION

Generally, heterogeneous application programs (i.e., programs written in different programming languages) currently are started directly by using launch methods that are specifically designed for launching the respective application programs. For example, programs written in C++ using Microsoft® Foundation Classes (MFC) run directly within the Windows® operating system, whereas Java™ application programs require running within a Java™ Virtual Machine (JVM), which itself runs under the Windows® operating system. These programs are written in different programming languages and are run using different execution methods. MFC uses software structures in C++ that are the Windows® base classes that are capable of responding to messages, generating windows, and from which application specific classes can be derived. Another example of a different execution method relates to batch files, which are executed in Disk Operating System (DOS) by entering the command of a batch file on a DOS command line.

Invoking applications can also be cumbersome and setting them up can be an error-prone task. Program invocation may be simple and direct, or it may be complex, requiring that multiple steps be taken. An example of a task that may be error-prone is developing a software installer program. The developer must make sure that the command line and the start directory are the same no matter which execution method is used to launch the program (e.g., regardless of whether the program is started using a desktop shortcut or the “Start” button in a Microsoft® Windows system). This often requires duplication on the part of the installer program developer, which might result in errors in specifying, for example, directory paths.

Also, when invoking an application program, it is possible for a user to specify an absolute drive path that is different from the current working directory. In this case, the application maybe running in the current working directory, but may require a file corresponding to the directory specified by the absolute drive path. The user may or may not be notified of the error, or the computer may simply crash. Essentially, whatever current methods are required for executing the program, registration among all Windows® program launch controls, such as, for example, shortcuts, Start Menu items, registry “Run” settings, etc., must be consistent to ensure that programs will be properly and consistently executed. The possibility of a mistake being made when these controls are set up is relatively high (especially at software installation time).

### SUMMARY OF THE INVENTION

Accordingly, a need exists for a method and an apparatus that enable heterogeneous application programs to be consistently launched, regardless of the execution methods used to launch the programs. The present invention comprises a memory device and logic, which is configured to execute a common launch program upon determining that an application has been invoked. For each application that utilizes the present invention, a key, a current working directory (CWD), and command information associated with the application are stored in the memory device. When the logic determines that an application has been invoked, the logic uses identity information relating to the application program to locate the key, the command information and the CWD associated with the application and uses the located command information and CWD to launch the particular application.

These and other features and advantages of the present invention will become apparent from the following discussion, drawings and claims.

### BRIEF DESCRIPTION OF THE DRAWINGS

FIG. 1 is a block diagram illustrating an example embodiment of the apparatus of the present invention.

FIG. 2 is a block diagram illustrating an example of the Window registry being used in accordance with the present invention.

FIG. 3 is a flow chart illustrating an example embodiment of the method of the present invention.

### DETAILED DESCRIPTION OF THE INVENTION

This invention preferably utilizes two main components, namely, a launch program, which preferably is an executable (e.g., HPI_Run.exe), and Windows® registry data stored in the Windows® registry. The launch program, hereinafter referred to solely for example purposes as an executable named “HPI_Run” uses registry data stored in the Windows® registry to run any desired application program, regardless of the language in which the application program was written and regardless of the method used to execute the application program. The location at which this executable is stored in memory is not critical. HPI_Run uses the name of the application program as a command line argument. If additional command line arguments are needed or are specified, they are passed directly to the launched application itself. For example, to launch a software component named “Application”, the following command would be used: HPI_Run Application arg1. arg2. HPI_Run would then run “Application” with the parameters arg1 and arg2.

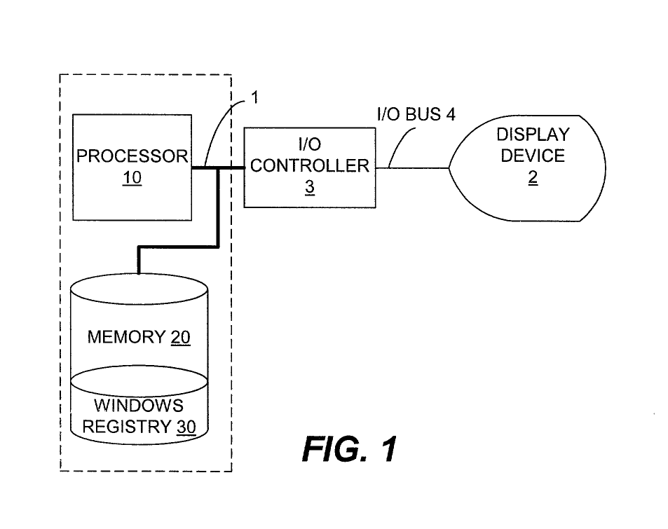

The apparatus of the present invention will now be discussed with reference to the embodiment shown in FIG. 1. The apparatus of the present invention is a computer 1, comprising a processor 10 and a memory device 20, which preferably is the hard drive of the computer 1. The computer 1 may be interfaced to a display monitor 2 and in communication therewith via an input/output (I/O) controller 3 and an I/O bus 4. A portion of the memory device 20 comprises the Windows® registry 30. To launch applications in accordance with the present invention, the processor 10 executes HPI_Run, which then looks up application data stored in the Windows® registry 30 using the name of the application as the key.

Application programs use the Windows® registry 30 and hardware may sometimes use it, but Window registry 30 is not generally meant to be accessed by the typical user. The Windows® registry 30 is an infrastructure mechanism of the computer 10 running Windows® and is typically set up by developers of installer programs and hardware developers. The data stored in the Windows® registry 30 is comprised of 3 components, namely, a “Command”, a “current working directory” (CWD), and a “SplashEnabled” value. The “Command” value specifies the actual command required to run the application program specified in the HPI_Run command line. Any extra arguments specified on the HPI_Run command line are appended to the actual command and are passed through to the application program. “CWD” specifies the current working directory for the application program to be launched. HPI_Run will change to this directory before executing the actual command specified in the Windows® registry 30. The “SplashEnabled” values controls whether or not a splash screen will be displayed before launching the application.

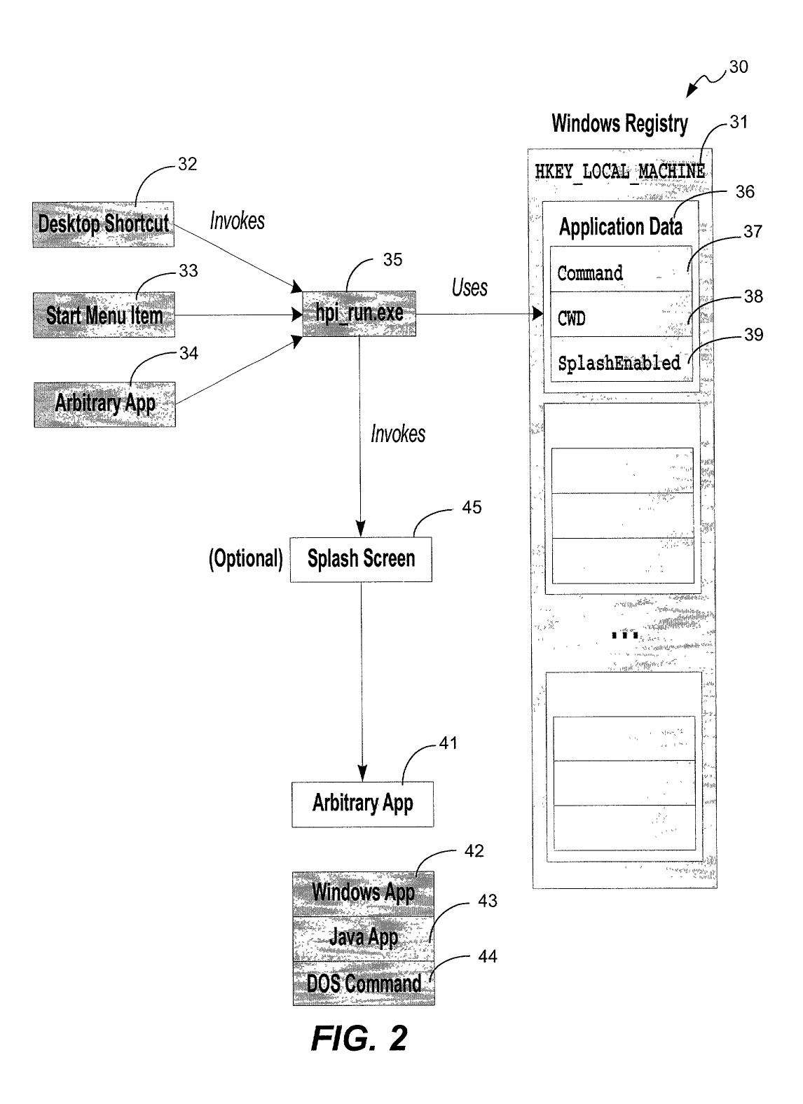

An example of the manner in which the apparatus shown in FIG. 1 performs all of these functions will now be described with reference to the example block diagram shown in FIG. 2. The Windows® registry data utilized by the present invention preferably is stored under “HKEY_LOCAL_MACHINE” area 31 of the Windows® registry 30 so that the registry data will be consistent among all users. In current Microsoft®Windows versions, a “Start” menu item is typically displayed in the bottom left-hand comer of the screen. This item is labeled with numeral 33 in FIG. 2. Typically, when an application program is installed, an icon or name identifying the application program is placed by the installer program under the “Start” menu item. The application program can be identified by the user by going through the names and icons listed under the “Start” menu item 33. An application program can then be launched by single clicking with a mouse input device on the icon or name identifying the program application that the user wishes to run.

One or more desktop shortcut 32 icons are typically displayed on the desktop corresponding of the Windows® main screen. A user can also launch an application by double clicking on the desk top icon identifying the application program the user wishes to run. Arbitrary applications 34 written in languages such as C⁺⁺ can also be designed and executed in similar fashions or through use of a command line. In all of these cases, a command line is associated with the icon or name of the application program and that command line, when executed, launches the corresponding application. These command lines and other information, such as the drive path to be used by the application program, have, in the past, been inserted by the installer of the program, and are different for different application programs.

In accordance with the present invention, however, the executable HPI_Run is substituted for the command lines of each of the applications that are to be launched in accordance with the present invention. This is indicated by the arrows drawn to block 35, labeled HPI_Run.exe, in FIG. 2. Thus, during installation of a particular application program, the installer replaces the command line and command line arguments normally specified for the application program by the designer or vendor, with the command line HPI_Run, followed by the name of the application program and any arguments to be used by the application program. Therefore, for example, if an icon for a particular application program is double clicked, and the present invention is being implemented for the particular application program, rather than the originally-specified command line being executed to launch the application, the executable HPI-Run will be executed. When HPI_Run is executed, the name of the application program contained in the HPI_Run command line will be used as a key to look up the corresponding application data 36 in the Hkey_Local_Machine portion 31 of the Windows® registry 30.

As stated above, for each application program implementing the present invention, the Windows® registry 30 will contain a “Command” 37, a “CWD” 38 and a “SplashEnabled” value 39. The installer program for a particular application program will be configured in accordance with the present invention to include these three components 37, 38 and 39. Therefore, the installer program will actually store these components 37, 38 and 39 in their proper locations in the Windows® registry 30. When HPI_Run is executed for a particular application by, for example, double clicking on the desktop icon associated with the specified application program, the HPI_Run executable 35 will use the application name contained HPI_Run command line to locate these components 37, 38 and 39 and then launch the application. Once these components are located, the HPI_Run executable 35 will use the command 37, the CWD 38 and the SplashEnabled value 39 to launch the application. As indicated by blocks 41, 42, 43 and 44, these applications may be, for example, an arbitrary application 41, some type of Windows® application 42, a Java™ application 43, or a DOS application 44. A splash screen 45 may or may not be displayed while the application is being launched, depending on whether the application has a splash screen associated with it. Those skilled in the art will understand, in view of the discussion provided herein, that the present invention is not limited with respect to the applications with which it can be implemented, or with respect to the languages in which the applications are written or their execution methods.

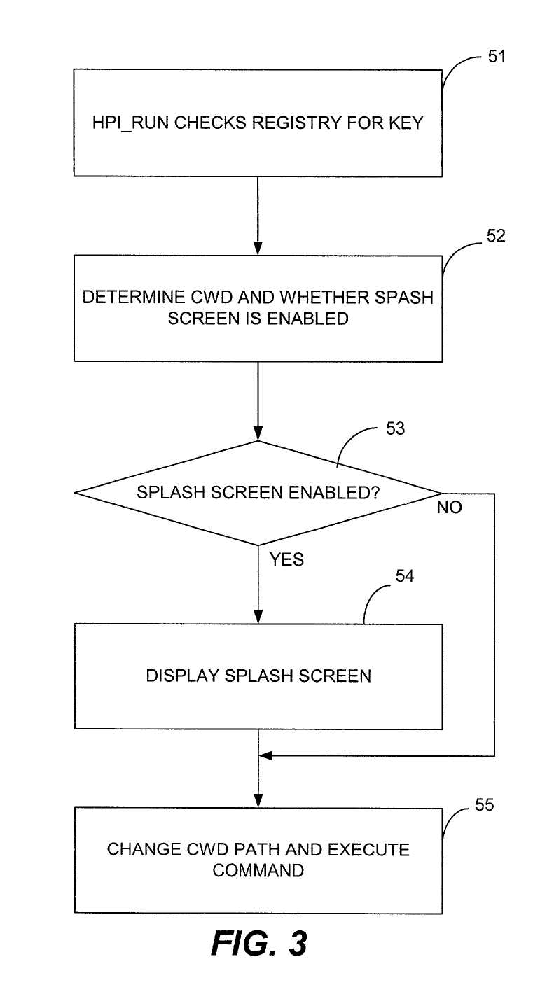

The manner in which the application is actually launched will now be described with reference to the flow chart of FIG. 3. When HPI_Run is executed, it looks into the Window® registry for the program application name (hereinafter referred to as the “key”), as indicated by block 51. If the key is found, the HPI_Run executable will determine the current working directory (CWD) and whether or not the SplashEnabled flag has been set, as indicated by blocks 52 and 53, respectively. If “SplashEnabled” is set to, for example,0, indicating that no splash screen is to be displayed, the HPI_Run will change to the CWD and then execute the command, passing along any arguments that were contained in the HPI_Run command line to the application, as indicated by block 55. If a determination is made that the “SplashEnabled” is enabled, HPI_Run will cause the splash screen to be displayed, as indicated by block 54, and then change to the CWD, and execute the command, passing along any arguments that were contained in the HPI_Run command line to the application, as indicated by the arrow from block 54 to block 55. The launched application is responsible for dismissing the splash screen.

It should be noted that although FIG. 2 shows the command 37 that actually executes the application program, the command 37 does not have to directly execute the application program. For example, the command 37 could be a command that executes another command, which, in turn, executes the application program. Also, the command 37 could be a pointer to some location in memory where a command is stored that either directly or indirectly causes the application program to be executed.

It can be seen from the discussion provided herein that the present invention provides a mechanism for ensuring that invoking any given application program will start it up consistently every time in exactly the same way. Also, because the correct current working directory is always specified in the Windows® registry, a desired application will not be invoked with the wrong drive path. Furthermore, the present invention reduces the number of steps needed to launch an application. For example, in the case of Java™ applications where the JVM must be invoked before the Java™ application can run, HPI_Run could automatically start up the JVM and start the application. In addition, the present invention reduces the potential for errors to be made by installer program designers because the designer only needs to ensure that the information placed in the Windows® registry is correct, thus eliminating the need to duplicate information in the installer program.

It should be noted that although the present invention has been described with reference to a particular embodiment, the present invention is not limited to the embodiment disclosed herein. For example, although the present invention has been discussed with reference to use of the Windows® registry, it will be understood by those skilled in the art, in view of the discussion provided herein, that other storage locations could be used for storing this information. It should also be noted that the present invention is not limited with respect to the type of computer with which it can be implemented. The term “computer”, as that term is used herein, is intended to denote any machine capable of receiving an input and of processing the input in accordance with a rule set. Furthermore, although the present invention has been described primarily with reference to a computer running Microsoft Windows®, those skilled in the art will understand, in view of the discussion provided herein, that the present invention is capable of being implemented with computer systems that are not running Microsoft® Windows®.

As long as the computer system has a feature similar to the Windows® registry that allows data for an application program to be stored and made available for different invocations of an application program, and which persists between invocations of an application program, the computer system should be suitable for use with the present invention. Also, although the memory device shown in FIG. 1 has been discussed as being a hard drive, those skilled in the art will understand that other memory devices can be used as well for this purpose. Other modifications can be made to the example embodiment provided herein that are also within the scope of the present invention.

What is claimed is:

1. An apparatus for launching computer application programs (applications), the apparatus comprising:
a memory device, wherein for any application to be launched by said apparatus, a key, a current working directory (CWD), and command information associated with said application are stored in said memory device; and
first logic, said first logic being configured to execute a launch computer program upon determining that a particular application has been invoked, wherein when said first logic determines that said particular application has been invoked, said first logic uses identity information corresponding to said particular application to locate said key, said command information and said CWD and uses the located command information and CWD to launch said particular application.

2. The apparatus of claim 1, wherein each key is identifiable from the name of the application with which said key is associated.

3. The apparatus of claim 1, wherein said command information is an execution command that executes said particular application.

4. The apparatus of claim 3, wherein if said command information associated with said particular application has one or more arguments associated therewith, said first logic appends said one or more arguments to said execution command so that said one or more arguments are utilized when said particular application is executed.

5. The apparatus of claim 1, wherein, for any application to be launched by said apparatus, a splash screen enable value is stored in said memory device, and wherein said first logic analyzes said splash screen enable value for said particular application being launched to determine whether a splash screen is to be displayed on a display device in communication with said apparatus.

6. The apparatus of claim 3, wherein if said first logic determines that said flash screen enable value is set, said first logic causes said splash screen to be displayed, changes to a drive path identified by said CWD and causes said execution command to execute said particular application.

7. The apparatus of claim 6, wherein said launch computer program is an executable, the executable having an executable command line associated therewith, the executable command line including a name of said particular application and any arguments to be used during execution of said particular application, and wherein said name is used to locate the key, command information, CWD and flash screen enable value associated said application.

8. The apparatus of claim 3, wherein if said first logic determines that said flash screen enable value is not set, said first logic changes to a drive path identified by said CWD and causes said execution command to execute said particular application.

9. The apparatus of claim 8, wherein said launch computer program is an executable that is executed when a particular executable command line is invoked, the executable command line including a name of said particular application and any arguments to be used during execution of said particular application, and wherein said name is used to locate the key, command information and CWD associated with said particular application.

10. The apparatus of claim 9, wherein said executable is the same for applications.

11. The apparatus of claim 9, wherein said executable is the same for applications that are executed using different execution techniques.

12. A method for launching computer application programs (applications), the method comprising the steps of:
upon determining that a particular application computer program has been invoked, using identity information relating to said particular application computer program to locate in memory a key, command information and a current working directory (CWD) associated with said particular application; and
using the located command information and CWD to launch said particular application.

13. The method of claim 12, wherein each key is identifiable from a name of the application with which said key is associated.

14. The method of claim 12, wherein said command information is an execution command that executes said particular application.

15. The method of claim 14, wherein if said command information associated with said particular application has one or more arguments associated therewith, said one or more arguments are appended to said execution command so that said one or more arguments can be utilized when said particular application is executed.

16. The method of claim 12, wherein said identity information is also used to locate a splash screen enable value in said memory, and wherein said method further comprises the step of analyzing said splash screen enable value for said particular application to determine whether a splash screen is to be displayed on a display device.

17. The method of claim 16, wherein said launch computer program is an executable, and wherein a command line associated with said executable includes a name of said particular application and any arguments to be used during execution of said particular application, and wherein said name is used to locate the key, command information, CWD and splash screen enable value associated said particular application.

18. The method of claim 16, wherein if a determination is made that said splash screen enable value is set, the step of using the located command information and the CWD includes the steps of causing a splash screen to be displayed, changing to a drive path identified by said CWD and causing said execution command to execute said application.

19. The method of claim 17, wherein if a determination is made that said splash screen enable value is not set, the step of using the located command information and the CWD comprises the steps of changing to a drive path identified by said CWD and causing said execution command to execute said particular application.

20. A launch computer program for launching computer application programs (applications), the launch computer program being embodied on a computer-readable medium, the launch computer program comprising:
a first code segment, the first code segment executing a launch computer program upon determining that a particular application has been invoked;
a second code segment, the second code segment using identity information relating to said particular application to locate in memory a key, command information and a current work drive (CWD) associated with said particular application; and
a third code segment, the third code segment using the located command information and CWD to launch said particular application.

21. The launch computer program of claim 20, wherein each key is identifiable from a name of the application with which the key is associated.

22. The launch computer program of claim 20, wherein said command information is an execution command that executes said application.

23. The computer program of claim 20, wherein if said command information associated with said particular application has one or more arguments associated therewith, said one or more arguments are appended to said execution command so that said one or more arguments can be utilized when said particular application is executed.

24. The method of claim 20, wherein the second code segment also uses said identity information relating to said particular application to locate a splash screen enable value in said memory for any application to be launched and analyzes said splash screen enable value for said particular application to determine whether a splash screen is to be displayed.

25. The computer program of claim 20, wherein said first and second code segments together comprise an executable, and wherein a command line associated with said executable includes a name of said particular application and any arguments to be used during execution of said particular application, and wherein said name is used by the second code segment to locate the key, command information, CWD and splash screen enable value associated said particular application.
